(19) United States
(12) Patent Application Publication
(10) Pub. No.: US 2026/0171589 A1
(43) Pub. Date: Jun. 18, 2026

(54) BATTERY PACK AND BEAM ASSEMBLY FOR BATTERY PACK

(71) Applicant: Ford Global Technologies, LLC, Dearborn, MI (US)

(72) Inventors: Larry Wang, Nanjing (CN); Shiwu Hao, Nanjing (CN); Fei Gao, Hefei (CN)

(73) Assignee: Ford Global Technologies, LLC, Dearborn, MI (US)

(21) Appl. No.: 19/418,065

(22) Filed: Dec. 12, 2025

(30) Foreign Application Priority Data
Dec. 12, 2024 (CN) 202411832592.3

(51) Int. Cl. H01M 50/291; H01M 10/658; H01M 50/204; H01M 50/249; H01M 50/264; H01M 50/367; H01M 50/507

(52) U.S. Cl. CPC H01M 50/291; H01M 10/658; H01M 50/249; H01M 50/264; H01M 50/367; H01M 50/507; H01M 50/204

(57) ABSTRACT

A battery pack includes a first battery unit, a second battery unit, a plate member, a thermal insulation plate, and an air flow channel. The plate member extends between the first battery unit and the second battery unit in a first direction. The thermal insulation plate is disposed between the plate member and the first battery unit. The first battery unit has a first vent hole facing the plate member. The air flow channel formed between the plate member and the thermal insulation plate.

### CROSS-REFERENCE TO RELATED APPLICATION

This application claims priority to and the benefit of Chinese Patent Application No. 202411832592.3, filed on Dec. 12, 2024. The disclosure of the above application is incorporated herein by reference.

### FIELD

The present disclosure relates to the field of vehicles, and specifically to a battery pack and a beam assembly for a battery pack.

### BACKGROUND

The statements in this section merely provide background information related to the present disclosure and may not constitute prior art.

With current market demands from consumers for vehicle fuel economy and environmental protection on the rise, various new energy vehicles—including but not limited to battery electric vehicles (BEVs), hybrid electric vehicles (HEVs), and plug-in hybrid electric vehicles (PHEVs)—have gained increasing popularity. These new energy vehicles will become one trend in the future development of the automotive industry due to their advantages such as energy efficiency, eco-friendliness, and cost-effectiveness.

Most new energy vehicles are equipped with battery packs. The battery pack is typically composed of multiple battery modules to supply power to the vehicle's electric motor, permitting the motor to provide driving force to the vehicle either independently or in conjunction with the vehicle's engine.

The battery pack typically includes multiple battery modules. As demands for the driving range and rapid charging of new energy vehicles increase, the charging voltage and battery capacity of new energy vehicle battery packs have increased correspondingly, and the number of battery modules has also risen. Most of these battery modules are installed in battery housings consisting of a tray and a cover, and packaged into a battery assembly via various fixing structures within the housing. When these fixing structures are used for battery packaging, challenges related to packaging, heat dissipation, and gas venting may arise.

In view of this, there remains room for further enhancement with regard to vehicle battery packs.

### SUMMARY

This section provides a general summary of the disclosure and is not a comprehensive disclosure of its full scope or all of its features.

The present disclosure provides aspects of various configurations and should not be used to limit the claims. Other implementations are contemplated in accordance with the techniques described herein, as will be apparent to those skilled in the art upon examination of the following drawings and detailed description, and such implementations are intended to be within the scope of this application.

The present disclosure provides a beam assembly for a battery pack, which can enhance the integration level and structural strength of the internal components of the battery pack, thus enhancing overall battery pack performance.

According to one configuration of the present disclosure, a battery pack is provided including a first battery unit, a second battery unit, a plate member, a first thermal insulation plate, and a first air flow channel. The plate member extends between the first battery unit and the second battery unit in a first direction. The first thermal insulation plate is disposed between the plate member and the first battery unit. The first battery unit has a first vent hole facing the plate member. The first air flow channel is formed between the plate member and the first thermal insulation plate.

According to another configuration of the present disclosure, the battery pack further comprises: a second thermal insulation plate disposed between the plate member and the second battery unit. The second thermal insulation plate has a second vent hole facing the plate member, and a second air flow channel is formed between the plate member and the second thermal insulation plate.

According to yet another configuration of the present disclosure, the battery pack further comprises: a first frame connected to at least one of the plate member and the first battery unit. The first thermal insulation plate is mounted to the first frame.

According to one configuration of the present disclosure, the plate member includes a first plate extending between the first battery unit and the second battery unit, and a second plate extending transversely to the first plate, and the plate member has an I-shaped, elongated U-shaped, T-shaped, cruciform or H-shaped cross-section.

According to another configuration of the present disclosure, the second plate has an upper surface on which a first connecting portion is formed, protruding upward and connected to a cover plate of the battery pack.

According to yet another configuration of the present disclosure, the first plate has a lower surface at the bottom, on which a second connecting portion is formed and connected to a tray of the battery pack.

According to one configuration of the present disclosure, a first gap is formed between adjacent battery units. The plate member is arranged in the first gap, and the second plate is arranged to overlay the first gap.

According to another configuration of the present disclosure, the first battery unit and the second battery unit each have lugs extending from their ends, and the plate member is formed with a third connecting portion that extends from an end thereof and is connected respectively to the lugs of the first battery unit and the second battery unit.

According to yet another configuration of the present disclosure, the first frame comprises a main frame body and busbars. The main frame body has a plurality of openings spaced apart in the first direction. The busbars are disposed in the first direction on the main frame body. Each busbars partially overlaying the openings.

According to one configuration of the present disclosure, a plurality of first vent holes are formed in the first frame and spaced apart in the first direction, and the plurality of first vent holes and the plurality of openings are respectively arranged in rows and parallel to one another in the first direction.

According to another configuration of the present disclosure, the first thermal insulation plate is arranged to overlay the plurality of openings of the main frame body and the plurality of first vent holes, and the first thermal insulation plate comprises a main plate body and a formed portion which is sheet-shaped and is connected to the main plate body via a formed arm.

According to yet another configuration of the present disclosure, a plurality of the formed portions are spaced apart in the first direction, each being respectively associated with a respective one of the plurality of first vent holes.

According to one configuration of the present disclosure, a plurality of the formed portions are spaced apart in the first direction, each being respectively associated with a respective one of the plurality of first vent holes and the plurality of openings.

According to another configuration of the present disclosure, the plurality of formed portions are arranged in a first row and a second row parallel to each other in the first direction, and the formed portions in the first row and the formed portions in the second row are arranged in a staggered or aligned pattern on the thermal insulation plate.

According to yet another configuration of the present disclosure, the first battery unit comprises battery cells which are electrically connected respectively to the busbars disposed on the first main frame body via tabs arranged on lateral sides of the battery cells.

According to one configuration of the present disclosure, a beam assembly for a battery pack is provided. The beam assembly includes a plate member, a first frame, and a first thermal insulation plate. The plate member extends in a first direction. The first frame is connected to the plate member and formed with a first vent hole facing the plate member. The first thermal insulation plate is arranged at a spacing from the plate member in the first direction along a lateral side of the plate member, such that a first air flow channel is formed between the plate member and the first thermal insulation plate.

According to another configuration of the present disclosure, the plate member includes a first plate extending in the first direction and a second plate extending transversely to the first plate, and the plate member has a T-shaped, cruciform or H-shaped cross-section.

According to yet another configuration of the present disclosure, the first frame includes a first main frame body and busbars. The first main frame body has a plurality of openings spaced apart in the first direction. The busbars are disposed in the first direction on the first main frame body, each partially overlaying the openings. A plurality of first vent holes are formed in the first main frame body and spaced apart in the first direction, and the plurality of first vent holes and the plurality of openings are arranged parallel to one another in the first direction.

According to one configuration of the present disclosure, the first thermal insulation plate is arranged to overlay the plurality of openings of the first main frame body and the plurality of first vent holes, and the first thermal insulation plate comprises a main plate body and a formed portion which is sheet-shaped and is connected to the main plate body via a formed arm.

According to another configuration of the present disclosure, the plurality of openings are partitioned by a plurality of spacer portions. At least one of the plurality of spacer portions is provided with one or more protrusions. The thermal insulation plate is formed with one or more holes whose positions correspond to those of the protrusions, and the thermal insulation plate is connected to the spacer portions by shape-fitting engagement between the holes and the protrusions and/or by thermally welding the holes to the protrusions.

Further areas of applicability will become apparent from the description provided herein. It should be understood that the description and specific examples are intended for purposes of illustration only and are not intended to limit the scope of the present disclosure.

### DRAWINGS

For a better understanding of the present disclosure, reference may be made to configurations depicted in the following drawings. The components in the drawings are not necessarily to scale and related elements may be omitted, or in some instances proportions may have been exaggerated, so as to emphasize and clearly illustrate the novel features described herein. In addition, system components can be variously arranged. Further in the figures, like reference numbers refer to like parts throughout the different figures.

FIG. 1 is a schematic diagram of a vehicle according to one form of the present disclosure;

FIG. 2 is a schematic diagram of a battery pack of the vehicle of FIG. 1 according to one form of the present disclosure;

FIG. 3 is an exploded schematic diagram of the battery pack of FIG. 2 according to one form of the present disclosure;

FIG. 4 is a schematic diagram of a battery module of the battery pack of FIG. 2 according to one form of the present disclosure;

FIG. 5 is a partial exploded schematic diagram of the battery pack of FIG. 2 according to one form of the present disclosure;

FIG. 6 is a cross-sectional schematic diagram of a beam assembly connected to a top cover and a tray of the battery pack of FIG. 2 according to one form of the present disclosure;

FIG. 7 is a partial schematic diagram of the battery module according to one form of the present disclosure;

FIG. 8 is a schematic diagram of a frame assembly of the battery pack of FIG. 2 according to one form of the present disclosure;

FIG. 9 is a partially enlarged schematic diagram of a main frame body of the frame assembly according to one form of the present disclosure;

FIG. 10 is a partially enlarged schematic diagram of a thermal insulation plate of the frame assembly according to one form of the present disclosure; and

FIG. 11 is a cross-sectional schematic diagram of the main frame body taken along line A-A of FIG. 9 of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Configurations of the present disclosure are described below. However, it is to be understood that the disclosed configurations are merely examples and other configurations may take various and alternative forms. The figures are not necessarily to scale; and some features may be exaggerated or minimized to show details of particular components. Therefore, specific structural and functional details disclosed herein are not to be interpreted as limiting, but merely as a representative basis for teaching one skilled in the art to variously employ the present disclosure. As will be understood by those of ordinary skill in the art, various features shown and described with reference to any one figure may be combined with features depicted in one or more other figures to produce configurations not expressly shown or described. The combinations of features shown herein provide representative configurations for typical disclosures. However, various combinations and modifications of the features consistent with the teachings of the present disclosure may be desired for certain particular applications or implementations.

In this application document, when an element or part is referred to as being “on . . . ”, “bonded to”, “connected to”, or “coupled to” another element or part, the element or part can be directly on another element or part, can be bonded, connected or coupled to another element or part, or there may be intervening elements or parts. In contrast, when an element is referred to as being “directly on . . . ”, “directly bonded to”, “directly connected to”, or “directly coupled to” another element or part, the intervening elements or parts may not be present. Other words used to describe the relationship between elements should be interpreted in a like fashion.

As mentioned in the background above, the present application have recognized that conventional battery packs are designed in an array and mounted on battery trays. Therefore, in some designs, a plurality of independent battery modules must be arranged. After being packaged, these battery modules are usually mounted on the tray via beam structures, and must be interconnected via a large number of busbars and buses. However, arranging more beam structures to fix the battery modules results in increased complexity and a low effective space utilization rate. In view of the aforementioned challenges, the present application provides, in one or more forms, a battery holder and a battery pack incorporating the battery holder, which is configured to address one or more challenges with conventional battery packs.

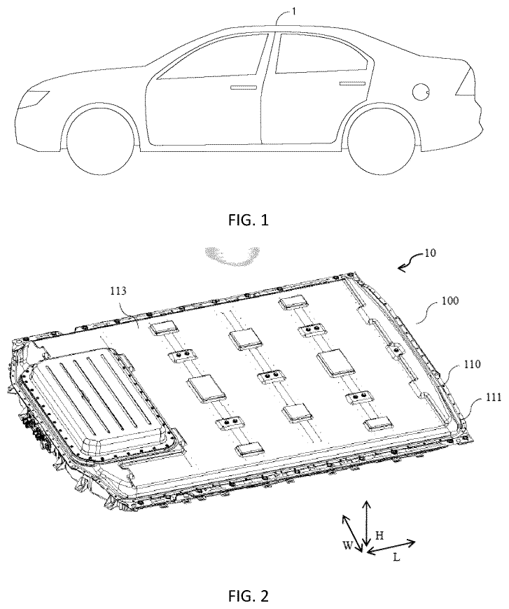

FIG. 1 is a schematic diagram of a vehicle 1 according to one form of the present disclosure. The vehicle 1 may refer to any means of transportation including a battery pack, for example, it may include but not limited to fossil fuel vehicles, electric vehicles (such as plug-in hybrid electric vehicles (PHEVs), full hybrid electric vehicles (FHEVs), mild hybrid electric vehicles (MHEVs), or battery electric vehicles (BEVs), etc.), and may even include ships, aircraft, and the like. The vehicle 1 may include components related to mobility, such as an engine, an electric motor, a transmission, a suspension, a driveshaft, and/or wheels, etc. The vehicle 1 may be non-autonomous, semi-autonomous (e.g., some routine motive functions controlled by the vehicle), or autonomous (e.g., motive functions are autonomously controlled by the vehicle without direct input from the user).

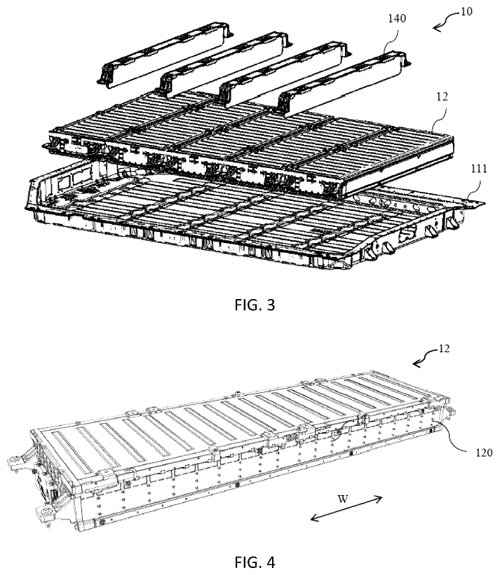

FIG. 2 is a schematic diagram of a battery pack 10 according to one form of the present disclosure, and FIG. 3 is a schematic diagram of a battery module 12 in the battery pack 10 according to one form of the present disclosure. In the exemplary forms depicted in FIGS. 2 and 3, the battery pack 10 includes a battery housing assembly 100 and the battery module 12 is received in the battery housing assembly 100. The battery housing assembly 100 may include a housing 110 and various possible functional components. The housing 110 may include a tray 111 configured to support the battery module 12 and a top cover 113 configured to cover the battery module 12. The tray 111 and the top cover 113 together define a receiving cavity for receiving the battery module 12. The tray 111 may be a box-like structure with a top opening, including a bottom wall and one or more side walls extending upward from the periphery of the bottom wall. The top cover 113 covers the top opening of the tray 111. The top cover 113 may be a box-like structure with a bottom opening, including a top wall and one or more side walls extending downward from the periphery of the top wall. The top opening of the tray 111 is abutted with the bottom opening of the top cover 113, so that the housing 110 encloses a substantially enclosed receiving cavity. Flanges may be disposed at the top opening of the tray 111 and the bottom opening of the top cover 113, with mating connection structures provided on the flanges to achieve the connection between the tray 111 and the top cover 113.

Those skilled in the art can understand that the top cover and the tray may adopt alternative configurations; for example, the tray may consist solely of a bottom wall, and the top cover may include side walls extending toward the tray and connected thereto, provided that the two can collectively define a space for receiving battery cells. The housing 110 defines a length direction L, a width direction W, and a height direction H. The battery module 12 may include a plurality of battery cells 11 arranged in an array. The plurality of battery cells 11 may be arranged in multiple rows. The battery cells 11 in each row are arranged along the width direction W of the housing 110, and the multiple rows are arranged along the length direction L of the housing 110. The battery module 12 may further include a battery management unit configured to control the charging and discharging of the plurality of battery cells 11. In one or more alternative implementations, the battery cells 11 may alternatively be arranged along the length direction L.

The battery pack 10 may be applied in various scenarios. In the configuration of the present disclosure, the battery pack 10 is applied to a vehicle. The length direction L, width direction W, and height direction H of the housing 110 may correspond respectively to the longitudinal direction (front-rear direction), lateral direction, and height direction of the vehicle.

Those skilled in the art should understand that while the battery housing assembly 100 is illustrated as receiving the battery module 12 in the above exemplary configurations, thereby serving as a housing assembly for the integrated battery pack 10, in alternative configurations, the battery housing assembly 100 may alternatively be configured to receive individual battery cells, thereby serving solely as a housing assembly for a simplified battery unit.

Referring to the exploded schematic diagram of the battery pack 10 with the top cover 113 removed depicted in FIG. 3, in the exemplary configuration, a plurality of battery modules 12 may be arranged in a stacked manner within the tray 111 along the length direction L, with a plurality of plate members 140 disposed between two adjacent battery modules 12. It can be understood that in alternative configurations, the battery modules 12 may be arranged in a diagonal configuration, and the plate members 140 may still be disposed between the diagonally arranged battery modules 12. Beyond being arranged between the battery modules 12, the plate members 140 may alternatively be disposed between the battery units containing different numbers of battery cells to form a partition therebetween.

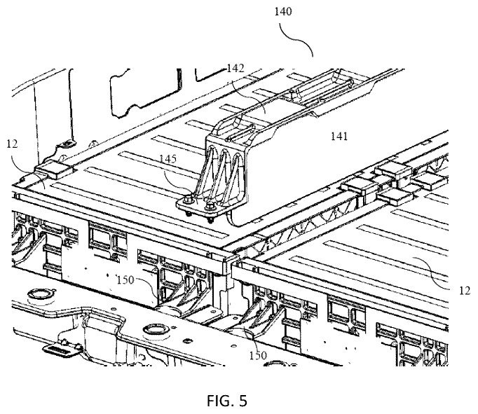

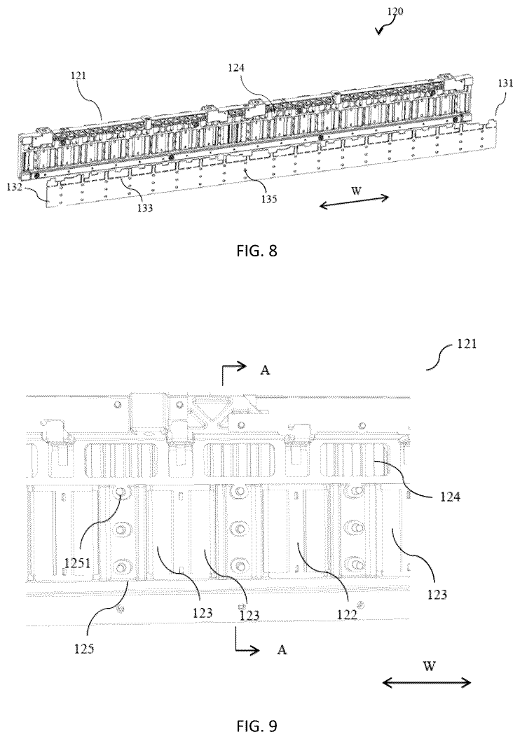

Referring next to the battery module 12 depicted in FIG. 4, in the exemplary configuration therein, the battery module 12 includes a plurality of battery cells 11 arranged in the first direction W, and the battery module 12 is integrally received in the receiving cavity defined by the tray and the top cover of the battery pack 10 depicted in FIG. 2. A frame assembly 120 is disposed along a lateral side of the battery module 12. With reference to the schematic diagram of the frame assembly 120 in the exemplary configuration shown in FIG. 8, the frame assembly 120 includes a main frame body 121 and a thermal insulation plate 131, both of which extend in the first direction W.

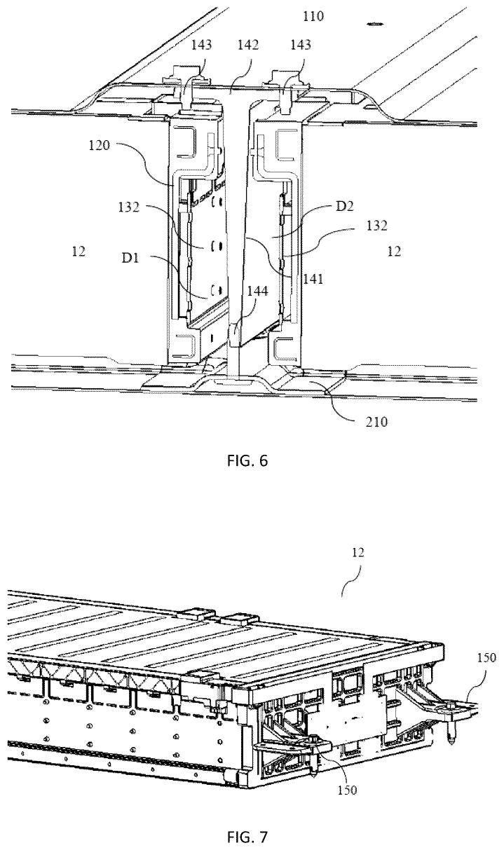

Referring further to the partially enlarged exploded schematic diagram of the interior of the battery pack 10 depicted in FIG. 5, in the exemplary configuration, two battery modules 12 are arranged adjacent to each other, with a plate member 140 disposed therebetween. The beam assembly includes the plate member 140 that extends in the first direction W. The plate member 140 has a first plate 141 extending in the first direction W and a second plate 142 extending transversely to the first plate 141. As shown in the cross-sectional schematic diagram of the plate member 140 depicted in FIG. 6, the first plate 141 and the second plate 142 define a T-shaped cross-section in this configuration. It can be understood that in one or more alternative configurations, the plate member 140 may have a cross-section of other configurations, such as I-shaped, elongated U-shaped, cruciform, or H-shaped. Among them, the elongated U-shaped plate member is a square-shaped plate member with a height-to-width ratio greater than 1, and the square-shaped plate member features a hollow structure, enabling the plate member to achieve weight reduction while maintaining sufficient structural strength. Additionally, the T-shaped and H-shaped plate members exhibit demolding advantages over the plate members of other configurations during the molding process.

As further shown in the exemplary configuration depicted in FIG. 6, the plate member 140 includes a first connecting portion 143 and a second connecting portion 144. The first connecting portion 143 is located on the second plate 142 and formed at both ends thereof. The first connecting portion 143 is configured to connect to the top cover 113 via fasteners, thereby securing the top cover 113 to the plate member 140. In other configurations of the present disclosure, the first connecting portion may project upward to reduce the distance between the first connecting portion and the top cover, facilitating the installation operation therebetween. The second connecting portion 144 is configured to connect to a bracket 210 on the tray 111, and the two are also fixed together by fasteners. The bracket 210 features a centrally raised structure to facilitate connection with the second connecting portion 144. The bracket 210 may be fixed to the tray 111 by welding. Additionally, in one or more alternative configurations, the second connecting portion 144 may be directly fixedly connected to the tray 111 without providing the bracket. In the configuration of the present disclosure, the first connecting portion 143 may be a through hole or a blind hole with internal threads, and the second connecting portion 144 may be a blind hole with internal threads. It is understood that besides connection via fasteners, the plate member 140 may also be connected to the top cover 113 and the tray 111 by other connection means such as welding and bonding.

Continuing to refer to FIG. 5 and in conjunction with the partially enlarged schematic diagram of the battery module 12 depicted in FIG. 7, the end of the battery module 12 is provided with two lugs 150 extending outward in the first direction W. The plate member 140 includes a third connecting portion 145 extending outward and downward from the end in the first direction W. The third connecting portion 145 may be respectively connected to the lugs 150 of two adjacent battery modules 12, thereby fixing both adjacent battery modules 12 to the plate member 140. Thus, an integral connection structure among the top cover 113, the tray 111, and the battery module 12 is formed via the plate member 140, which enhances the integration level of the battery pack 10, enhances the integrity between various internal components thereof, and enhances the NVH performance (Noise, Vibration, Harshness) of the vehicle.

Referring next to FIG. 6, in the exemplary configuration depicted therein, thermal insulation plates 131 are disposed between the battery modules 12 and the plate member 140, defining a first air flow channel D1 and a second air flow channel D2 between the adjacent battery modules 12 and the two sides of the plate member 140. It is understood that in alternative configurations of the present disclosure, the air flow channel may be formed on only one side. By disposing the thermal insulation plate 131 on one side and forming the air flow channel, heat transfer between different battery modules 12 can also be inhibited. The second plate 142 overlays the gap between the adjacent battery modules 12, endowing the first air flow channel D1 and the second air flow channel D2 with a certain degree of closure to guide air flow and heat. In the configuration of the present disclosure, the thermal insulation plate 131 is disposed on the frame assembly 120. It is understood that in other configurations of the present disclosure, the thermal insulation plate may also be directly disposed on a lateral side of the battery module 12 or connected to the plate member 140. In one configuration of the present disclosure, a receiving groove may be provided on the transversely extending second plate of the T-shaped or H-shaped plate member, enabling the thermal insulation plate 131 to be inserted into the receiving groove to form a detachable connection with the T-shaped or H-shaped plate member. This connection method facilitates installation and easy replacement of the thermal insulation plate 131. It is understood that the thermal insulation plate 131 may also be connected to the plate member by other means, such as thermal welding, bonding, and fastener connection.

Referring next to the exploded schematic diagram of the frame assembly 120 depicted in FIGS. 8 and 9, the frame assembly 120 includes the main frame body 121 and the thermal insulation plate 131. The main frame body 121 has a plurality of openings 122 (FIG. 9) spaced apart in the first direction W. A plurality of busbars 123 (FIG. 9) are disposed on the main frame body 121, and each opening 122 is partially overlayed by two spaced busbars 123. The plurality of openings 122 are partitioned by a plurality of spacer portions 125. Each spacer portion 125 is provided with a plurality of protrusions 1251. In the configuration depicted in FIGS. 8 and 9, the number of the protrusions 1251 is three. It is understood that the number of the protrusions 1251 may be adjusted as needed.

In one or more configurations of the present disclosure, the plurality of busbars 123 may be integrally formed with the main frame body 121 by molding. It is understood that in other configurations of the present disclosure, the busbars 123 may be connected to the main frame body 121 by various connection means such as bonding, welding, and fastener connection. Continuing with the exemplary configuration depicted in FIGS. 8 and 9, a plurality of vent holes 124 are formed in the main frame body 121 and spaced apart in the first direction W. The plurality of vent holes 124 are arranged toward the first plate 141 of the plate member 140, allowing heat and gas to be discharged toward the first air flow channel D1 and/or the second air flow channel D2 through the vent holes 124. In one or more configurations of the present disclosure, as depicted in FIG. 11 (a cross-sectional view of the main frame body 121 taken along the line A-A of FIG. 9), the main frame body 121 is formed by injection molding. The main frame body 121 can be made of metal materials such as steel or aluminum, or other high-strength non-metallic materials, such as glass fiber or carbon fiber reinforced plastic. During the injection molding process, reinforcing members 128 extending in the first direction W are embedded in both an upper side beam 126 and a lower side beam 127 of the main frame body 121. In the configuration depicted in FIG. 11, the reinforcing member 128 has a C-shaped cross-section. It is understood that in other configurations, the reinforcing member may have different cross-sectional shapes such as U-shaped and X-shaped. In one or more configurations of the present disclosure, the reinforcing member 128 disposed in the main frame body 121 may be made of metal materials, such as steel, aluminum, or other high-strength materials. The reinforcing member 128 molded in the main frame body 121 can effectively enhance the overall structural strength of the main frame body 121, and the use of C-shaped, U-shaped, and/or X-shaped cross-sections can effectively enhance the strength while maintaining the lightweight characteristic of the main frame body 121.

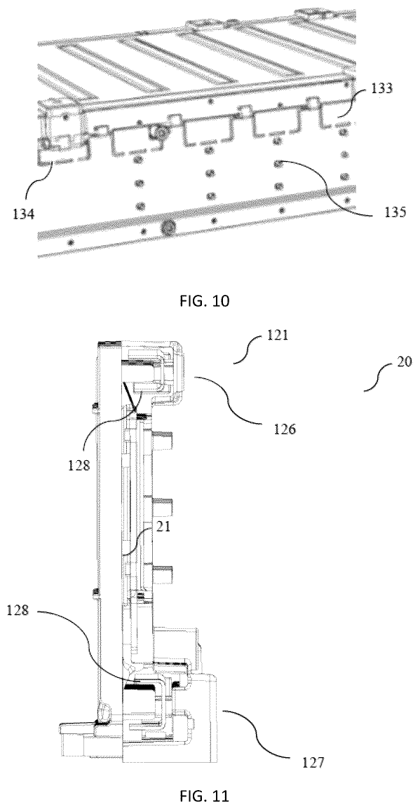

Referring next to FIG. 8, in the exemplary configuration of the frame assembly 120 depicted therein, the thermal insulation plate 131 includes a main plate body 132 and a formed portion 133. With reference to the partially enlarged schematic diagram of the thermal insulation plate 131 depicted in FIG. 10, the formed portion 133 is connected to the main plate body 132 via a formed connecting arm 134. In one or more configurations of the present disclosure, the formed connecting arm 134 may be implemented by removing part of the material of the thermal insulation plate 131 between the main plate body 132 and the formed portion 133 to form a formed connection between the two. As depicted in FIG. 8, a plurality of formed portions 133 of the thermal insulation plate 131 may be in one-to-one correspondence with the vent holes 124 on the main frame body 121. It is understood that in other configurations of the present disclosure, the number of formed portions may be set as needed, and each formed portion may overlay one or more vent holes 124. For example, in one configuration, the thermal insulation plate 131 may have only one formed portion configured to overlay all the vent holes 124. In alternative configurations, the formed portions may be arranged in two parallel rows in the first direction W, and the formed portions in the first row and the second row may be arranged in an aligned or staggered pattern on the thermal insulation plate. Thermal insulation plates with different formed portion arrangements exhibit different gas discharge capabilities toward the air flow channel. Further, the formed portions in different rows may have different first separation thresholds and second separation thresholds, wherein the second separation threshold is greater than the first separation threshold. Thus, when the exhaust pressure exceeds the first separation threshold, only part of the formed portions detach to open part of the vent holes; when the exhaust pressure exceeds the second separation threshold, all the vent holes are opened to achieve faster gas discharge.

As further shown in the exemplary configuration depicted in FIG. 10, the thermal insulation plate 131 is formed with a plurality of holes 135, whose positions correspond to those of the plurality of protrusions 1251 on the spacer portions 125 of the main frame body 121. When connecting the thermal insulation plate 131 to the main frame body 121, thermal welding may be used. For example, the plurality of protrusions 1251 are heated to a hot-melt state, and then the thermal insulation plate 131 is abutted to the main frame body 121 from the side with the plurality of protrusions 1251, such that the plurality of protrusions 1251 and the plurality of holes 135 are welded together to realize the connection between the thermal insulation plate 131 and the main frame body 121. In alternative configurations of the present disclosure, the thermal insulation plate 131 and the main frame body 121 may also be connected via an interference fit between the plurality of protrusions 1251 and the plurality of holes 135 without thermal welding.

The beam assembly in the configurations of the present disclosure includes the plate member 140, the main frame body 121, and the thermal insulation plate 131. The main frame body 121 may be connected to the plate member 140 by means of thermal welding, bonding, or fastener connection. The thermal insulation plate 131 may also be connected to the main frame body 121 by the same means. Thus, the beam assembly is capable of fixing different battery modules 12, securing the different battery modules 12 to the top cover 113 and the tray 111, isolating heat between the different battery modules 12, and forming air flow channels to directionally discharge heat and gas

### Generated by the Battery Modules 12.

Referring next to the battery module 12 in the exemplary configuration depicted in FIG. 4, the frame assembly 120 extends in the first direction W from a lateral side of the battery module 12 and is attached thereto from the lateral side. In the exemplary configuration of the present disclosure, the battery cells 11 in the battery module 12 are arranged in a stacked manner in the first direction W. Each battery cell 11 has a tab that is arranged toward the lateral side. This allows the battery cells to be electrically coupled to the plurality of busbars 123 of the frame assembly 120 via the tabs arranged on the lateral sides. The attachment of the frame assembly 120 to the lateral side of the battery module 12 facilitates the electrical connection of the battery cells 11 within the battery module 12 by means of the busbars 123 molded therein. When heat and gas are generated by the battery module 12, the heat can be blocked by the thermal insulation plate 131, providing that the heat generated by the battery module 12 does not affect other battery modules and electronic devices in the battery pack 10. Additionally, when a large amount of hot gas is generated in a short time, the formed connecting arms 134 between the formed portions 133 of the thermal insulation plate 131 and the main plate body 132 is configured to separate under the action of gas pressure, causing the formed portions 133 to separate from the main plate body 132. This enables the plurality of vent holes 124 on the main frame body 121 to open, allowing the heat and gas to be rapidly discharged to the outside of the battery module 12 through the vent holes 124 and directionally discharged via the first air flow channel D1 and/or the second air flow channel D2.

It should be understood that, on the premise of technical feasibility, the technical features listed above for different configurations can be combined with each other to form other configurations within the scope of the present disclosure.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-mentioned configurations are possible examples of implementations of the present disclosure and are given only for the purpose of enabling those skilled in the art to clearly understand the principles of the disclosure. It should be understood by those skilled in the art that the above discussion to any configuration is only exemplary, and is not intended to imply that the disclosed scope of the configurations of the present disclosure (including claims) is limited to these examples; and under the overall concept of the disclosure, the technical features in the above configurations or different configurations can be combined with each other to produce many other changes in different aspects of configurations of the disclosure that is not provided in detailed description for the sake of brevity. Therefore, any omission, modification, equivalent replacement, improvement, etc. made within the spirit and principle of the configuration of the disclosure shall be included in the scope of protection claimed by the disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A battery pack, comprising:
a first battery unit;
a second battery unit;
a plate member extending between the first battery unit and the second battery unit in a first direction;
a first thermal insulation plate disposed between the plate member and the first battery unit, wherein the first battery unit has a first vent hole facing the plate member; and
a first air flow channel formed between the plate member and the first thermal insulation plate.

2. The battery pack according to claim 1, further comprising a second thermal insulation plate disposed between the plate member and the second battery unit, and wherein the second thermal insulation plate has a second vent hole facing the plate member, and a second air flow channel is formed between the plate member and the second thermal insulation plate.

3. The battery pack according to claim 1, further comprising a first frame connected to at least one of the plate member and the first battery unit, and wherein the first thermal insulation plate is mounted to the first frame.

4. The battery pack according to claim 2, wherein the plate member includes a first plate extending between the first battery unit and the second battery unit, and a second plate extending transversely to the first plate, and wherein the plate member has an I-shaped, elongated U-shaped, T-shaped, cruciform or H-shaped cross-section.

5. The battery pack according to claim 4, wherein the second plate has an upper surface on which a first connecting portion is formed, protruding upward and connected to a cover plate of the battery pack.

6. The battery pack according to claim 4, wherein the first plate has a lower surface at a bottom, on which a second connecting portion is formed and connected to a tray of the battery pack.

7. The battery pack according to claim 4, wherein the first battery unit and the second battery unit are adjacent to each other and form a first gap therebetween, the plate member is arranged in the first gap, and the second plate is arranged to overlay the first gap.

8. The battery pack according to claim 4, wherein the first battery unit and the second battery unit each have lugs extending from respective ends, and the plate member is formed with a third connecting portion that extends from an end thereof and is connected respectively to the lugs of the first battery unit and the second battery unit.

9. The battery pack according to claim 3, wherein the first frame comprises:
a main frame body having a plurality of openings spaced apart in the first direction; and
busbars disposed in the first direction on the main frame body, each partially overlaying the plurality of openings.

10. The battery pack according to claim 9, wherein a plurality of first vent holes are formed in the first frame and spaced apart in the first direction, and wherein the plurality of first vent holes and the plurality of openings are respectively arranged in rows and parallel to one another in the first direction.

11. The battery pack according to claim 10, wherein the first thermal insulation plate is arranged to overlay the plurality of openings of the main frame body and the plurality of first vent holes, and the first thermal insulation plate comprises a main plate body and at least one formed portion which is sheet-shaped and is connected to the main plate body via a formed arm.

12. The battery pack according to claim 11, wherein the at least one formed portion includes a plurality of the formed portions, the plurality of formed portions are spaced apart in the first direction, each being respectively associated with a respective one of the plurality of first vent holes.

13. The battery pack according to claim 11, wherein the at least one formed portion includes a plurality of the formed portions, the plurality of formed portions are spaced apart in the first direction, each being respectively associated with a respective one of the plurality of first vent holes and the plurality of openings.

14. The battery pack according to claim 13, wherein the plurality of formed portions are arranged in a first row and a second row parallel to each other in the first direction, and the formed portions in the first row and the formed portions in the second row are arranged in an aligned or staggered pattern on the first thermal insulation plate.

15. The battery pack according to claim 9, wherein the first battery unit comprises battery cells which are electrically connected respectively to the busbars disposed on the main frame body via tabs arranged on lateral sides of the battery cells.

16. A beam assembly, comprising:
a plate member extending in a first direction;
a first frame connected to the plate member and formed with at least one first vent hole facing the plate member; and
a first thermal insulation plate, wherein the first thermal insulation plate is arranged at a spacing from the plate member in the first direction along a lateral side of the plate member such that a first air flow channel is formed between the plate member and the first thermal insulation plate.

17. The beam assembly according to claim 16, wherein the plate member includes a first plate extending in the first direction and a second plate extending transversely to the first plate, and the plate member has a T-shaped, cruciform or H-shaped cross-section.

18. The beam assembly according to claim 16, wherein the first frame comprises:
a first main frame body having a plurality of openings spaced apart in the first direction; and
busbars disposed in the first direction on the first main frame body, each partially overlaying the plurality of openings;
wherein the at least one first vent hole includes a plurality of first vent holes formed in the first main frame body and spaced apart in the first direction, and the plurality of first vent holes and the plurality of openings are arranged parallel to one another in the first direction.

19. The beam assembly according to claim 18, wherein the first thermal insulation plate is arranged to overlay the plurality of openings of the first main frame body and the plurality of first vent holes, and the first thermal insulation plate comprises a main plate body and a formed portion which is sheet-shaped and is connected to the main plate body via a formed arm.

20. The beam assembly according to claim 18, wherein the plurality of openings are partitioned by a plurality of spacer portions, at least one of the plurality of spacer portions is provided with one or more protrusions, the first thermal insulation plate is formed with one or more holes positioned to correspond to the one or more protrusions, and the first thermal insulation plate is connected to the plurality of spacer portions by shape-fitting engagement between the one or more holes and the one or more protrusions and/or by thermally welding the one or more holes to the one or more protrusions.
